(19) United States
(12) Patent Application Publication
(10) Pub. No.: US 2009/0223995 A1
(43) Pub. Date: Sep. 10, 2009

(54) Seasoning powder container

(76) Inventor: Hsieh-Min Tu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,743

(22) Filed: Mar. 10, 2008

(51) Int. Cl. B05B 11/02

(52) U.S. Cl. 221/312 C

(57) ABSTRACT

A container includes a containing body, a moving rod component held in the body, a base joined on a lower end of the body, a pressing member positioned on a top of the body and joined to the moving rod component, and a compressible elastic element to bias the pressing member upwards; the base has a tapering dispensing hole; the moving rod component has a connecting element on a lower portion, which has substantially the same diameter as the smallest portion of the dispensing hole, and usually blocks the dispensing hole, and which will move out of the dispensing hole to allow seasoning powder to fall through the dispensing hole when the pressing member is depressed; the moving rod component has a stirring spring positioned therearound, which will move together with the moving rod component to prevent seasoning powder in the containing body from sticking together to form large lumps.

### BACKGROUND OF THE INVENTION

1. Field of the Invention

The present invention relates to a seasoning powder container, more particularly one, which allows one to easily control the amount of seasoning powder that is dispensed from the container per unit of time, and which can prevent seasoning powder therein from sticking together.

2. Brief Description of the Prior Art

Various seasonings play an important roll in the cuisines. Soybean sauce, vinegar, salt, pepper powder, and chili powder are among the popular seasonings.

Shown in FIG. 4 is an ordinary container for seasonings in powder form, which has a containing body 6, and a lid 7 joined on a top of the containing body 6. The lid 7 has several holes 71 thereon so that seasoning powder can be dispensed through the holes 71 when the container is held up side down.

The above seasoning powder container is found to have the following drawbacks:

1. The seasoning powder can be subjected to moisture in the air, and therefore will stick together to form large lumps incapable of falling through the holes of the lid after a certain length of time.

2. Too much seasoning powder can come out of the container through the holes of the lid suddenly when one tilts or inverts the container to dispense seasoning powder.

3. The holes of the lid have a fixed size therefore the user can't control the amount of seasoning powder that is dispensed through the holes every time he tilts or inverts the container.

### SUMMARY OF THE INVENTION

It is a main object of the present invention to provide a seasoning powder container to overcome the above problems.

A seasoning powder container according to an embodiment of the present invention consists of a containing body, a moving rod component in the body, a base joined on a lower end of the body, and a pressing member, which is positioned on a top of the body and joined to the moving rod component, and is biased upwards with a compressible elastic element. The base has a tapering dispensing hole. The moving rod component has a large bottom portion, which has substantially the same diameter as the smallest portion of the dispensing hole, and usually blocks the dispensing hole, and which will move out of the dispensing hole so as to allow seasoning powder to fall through the dispensing hole when the,pressing member is depressed. Therefore, one can control the amount of seasoning powder that is dispensed from the container per unit of time by means of changing the magnitude of the depressing force that he is exerting on the pressing member. Furthermore, the moving rod component has a stirring spring positioned therearound, which will move together with the moving rod component to prevent seasoning powder in the containing body from sticking together to form large particles.

### BRIEF DESCRIPTION OF THE DRAWINGS

The present invention will be better understood by referring to the accompanying drawings, wherein:

FIG. 1 is an exploded perspective view of a seasoning powder container in accordance with an embodiment of the present invention,

FIG. 2 is a sectional view of the present invention,

FIG. 3 is a sectional view of the present invention in use, and

FIG. 4 is a sectional view of the prior art.

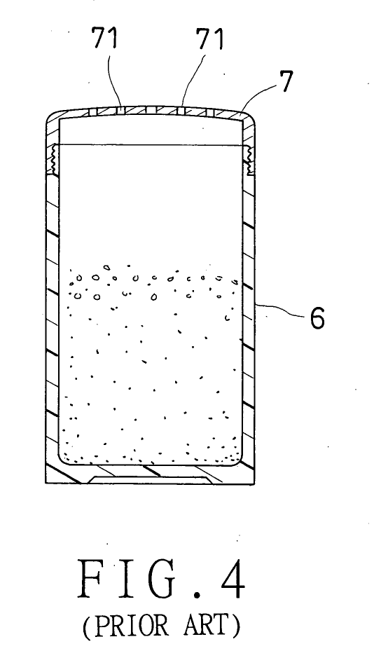

### DETAILED DESCRIPTION OF THE PREFERRED EMBODIMENTS

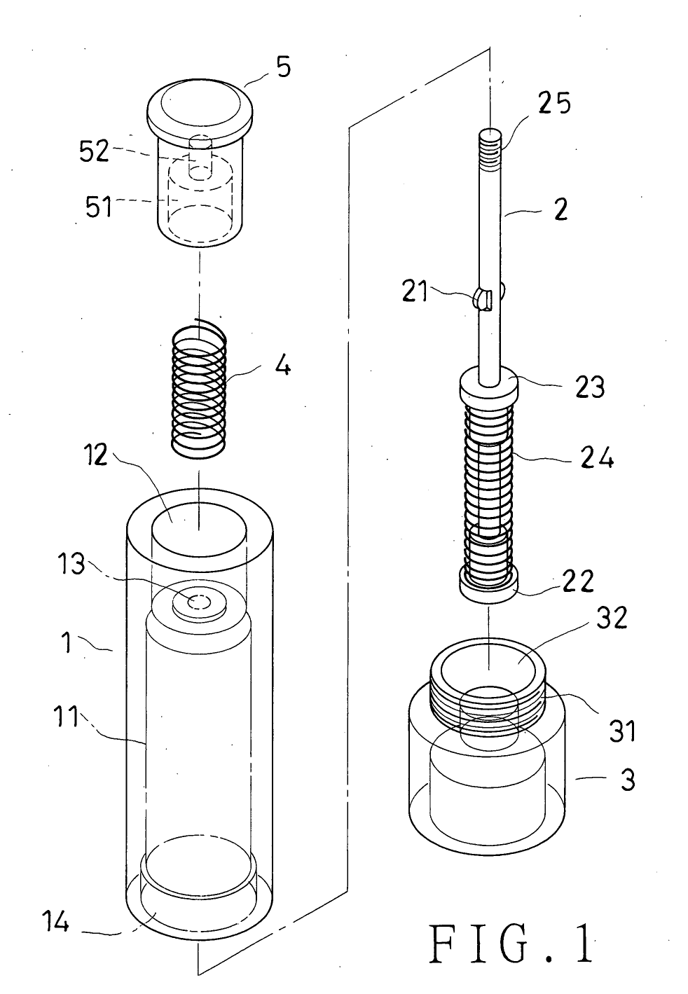

Referring to FIG. 1, a preferred embodiment of a seasoning powder container of the present invention consists of a containing body 1, a moving rod component 2, a base 3, a compressible elastic element 4, and a pressing member 5.

The containing body 1 has first and second hollow holding portions 11 and 12, and a through hole 13 formed between and communicating with both the first and the second hollow holding portions 11 and 12; the first holding portion 11 is used to hold seasoning powder. The first hollow holding portion 11 has an opening on a lower end, and has threads 14 on an inner side of a lower portion thereof. The compressible elastic element 4 is held in the second hollow holding portion 12 of the containing body 1.

The moving rod component 2 is passed through the compressible elastic element 4, the first holding portion 11, the through hole 13, and the second holding portion 12 of the containing body 1. The moving rod component 2 has two stopping pieces 21 thereon, which are under the through hole 13 in the first hollow holding portion 11 of the containing body 1, and can't pass through the through hole 13. The stopping pieces 21 divide the moving rod component 2 into first and section portion. The moving rod component 2 has first and second connecting elements 22 and 23 joined on the first portion, which is under the stopping pieces 21. A stirring spring 24 is positioned around the moving rod component 2, between the first and the second connecting elements 22 and 23. The second portion of the moving rod component 2 is received in the second holding portion 12 of the containing body 1, and has threads 14 thereon.

The base 3 has threads 31 on an outer circumferential portion thereof, and is joined to the containing body 1 with the threads 31 engaging the threads 14. The base 3 has a tapering dispensing hole 32 therein, and the smallest portion of the dispensing hole 32 has substantially the same diameter as the first connecting element 22 joined on the moving rod component 2.

The pressing member 5 has a holding room 51 with an opening facing downwards, and a screw hole 52 in the holding room 51. The pressing member 5 is joined on the second portion of the moving rod component 2 with the screw hole 52 engaging the threads 25, and with one end of the compressible elastic element 4 being received in the holding room 51. Therefore, the compressible elastic element 4 will move the pressing member 5 back to a usual higher position as soon as the user lets go of the pressing member 5 after having depressed the pressing member 5.

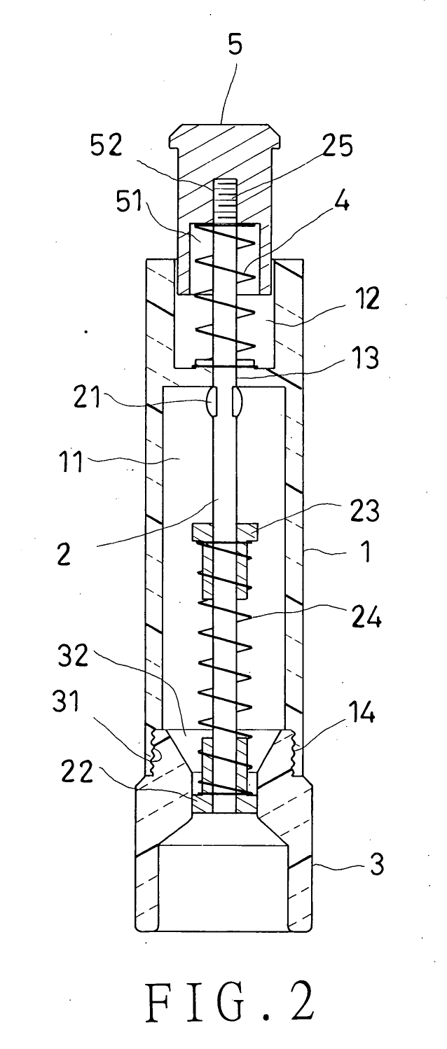

In assembly, referring to FIG. 2, the moving rod component 2 is passed through the first holding portion 11, the through hole 13 and the second holding portion 12 of the containing body 1 from the second portion thereof. And, the compressible elastic element 4 is positioned around the second portion of the moving rod component 2. Next, the pressing member 5 is threadedly joined to the second portion of the moving rod component 2, and the base 3 is threadedly joined to the lower portion of the first holding portion 11 of the containing body 1.

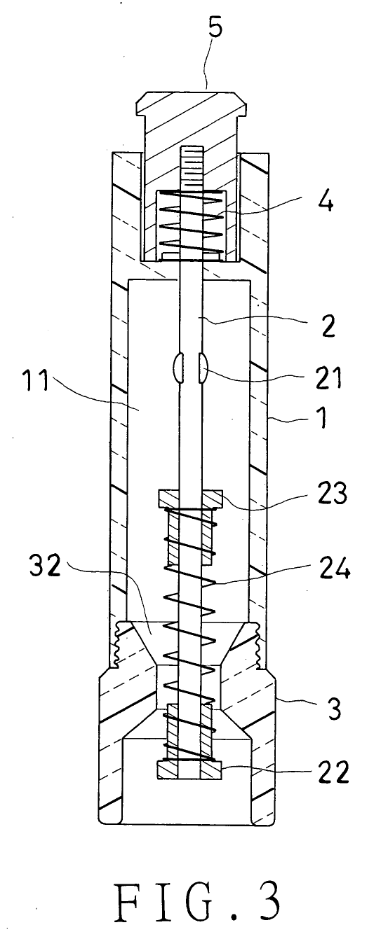

The first connecting element 22 of the moving rod component 2 will usually be received in the dispensing hole 32 to block the base 3 if the pressing member 5 isn't depressed; thus, seasoning powder can't be passed out of the containing body 1 through the dispensing hole 32, as shown in FIG. 2. Referring to FIG. 3, when the pressing member 5 is depressed with the elastic element 4 being compressed, the moving rod component 2 will move down, and in turn the first connecting element 22 will be moved out of the dispensing hole 32 to no longer block the base 3; thus, seasoning powder will fall out through the dispensing hole 32. At the same time, the stirring spring 24 around the moving rod component 2 will stir seasoning contained in the containing body so as to prevent the seasoning powder from sticking together to form large particles.

The elastic element 4 will force the pressing member 5 and the moving rod component 2 to move back to the original position as soon as the user lets go of the pressing member 5 after having depressed the pressing member 5. In addition, the size of the aperture between the first connecting element 22 and the base 3 depends on the distance between the first connecting element 22 and the dispensing hole 32; the aperture will become larger when the distance between the first connecting element 22 and the dispensing hole 32 increases. Therefore, the user can control the amount of seasoning powder dispensed per unit of time by means of changing the amount of the depressing force on the pressing member 5; relatively small amount of seasoning will fall out of the containing body 1 per unit of time if the user depresses the pressing member 5 only a short distance.

From the above description, it can be seen that the present invention has the following advantages:

1. One is allowed to control the amount of seasoning powder that is dispensed from the container per unit of time by means of changing the magnitude of the depressing force that he is exerting on the pressing member. Therefore, the present invention is convenient to use.

2. When the pressing member is being operated, the stirring spring will move up and down together with the moving rod component to stir seasoning powder in the container. Therefore, the seasoning powder won't stick together to form large lumps after having been held in the container for a certain length of time.

What is claimed is:

1. A seasoning powder container, comprising
a containing body; the containing body having a first hollow holding portion extending to a first end thereof; the first hollow holding portion having an opening on said first end;
a moving rod component held in the first holding portion of the containing body; the moving rod component having first and second portion; the second portion of the moving rod component sticking out of the first hollow holding portion; the first portion of the moving rod component having a stirring spring thereon; the first portion of the moving rod component having a first connecting element secured thereon to prevent the stirring spring from separating therefrom;
a base secured on the opening of the first hollow holding portion of the containing body; the base having a tapering dispensing hole therein; a smallest portion of the dispensing hole having substantially a same diameter as a largest portion of the first connecting element;
a compressible elastic element positioned around the second portion of the moving-rod component; and
a pressing member positioned on the compressible elastic element and joined on the second portion of the moving rod component to be subjected to force of the compressible elastic element.

2. The seasoning powder container as claimed in claim 1, wherein the containing body has a second hollow holding portion extending to a second end thereof, and has a through hole between and communicating with both the first and the second hollow holding portions; the moving rod component being passed through the through hole.

3. The seasoning powder container as claimed in claim 2, wherein the moving rod component having a plurality of stopping pieces thereon, which are under the through hole of the containing body.

4. The seasoning powder container as claimed in claim 1, wherein the second portion of the moving rod component has threads thereon, and the pressing member has a screw hole, which is threadedly engaged with the threads to join the moving rod component and the pressing member together.

5. The seasoning powder container as claimed in claim 1, wherein the moving rod component has a second connecting element above the first connecting element, and the stirring spring is positioned between the first and the second connecting element.

6. The seasoning powder container as claimed in claim 1, wherein the base has threads on an outer circumferential portion thereof, and the first hollow holding portion of the containing body has threads on an inner side thereof, which are threadedly engaged with the threads of the base to join the first hollow holding portion and the base together.
